(19) United States
(12) Patent Application Publication
(10) Pub. No.: US 2026/0211894 A1
(43) Pub. Date: Jul. 23, 2026

(54) MANAGEMENT OF TEMPORAL RELEVANT DATA RETRIEVAL

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/034,860

(22) Filed: Jan. 23, 2025

(51) Int. Cl. G06F 16/2458; G06F 16/242

(52) U.S. Cl. CPC G06F 16/2477; G06F 16/242

(57) ABSTRACT

Methods and systems for managing operation of a data processing system are disclosed. A retrieval-augmented generation (RAG) process for a prompt may be performed to obtain data chunks. A portion of the data chunks may be discriminated based on a relevant time period identified based on the prompt to obtain temporally relevant data chunks. A response may be obtained from a trained machine learning model using the prompt and/or the temporally relevant data chunks. The response may be used to provision desired computer implemented services.

### FIELD

Embodiments disclosed herein relate generally to managing data processing systems. More particularly, embodiments disclosed herein relate to systems and methods to manage operation of the data processing systems using inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2B show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems that may provide computer-implemented services. The computer-implemented services may be provided using inference models (e.g., artificial intelligence models). The inference models may be used to generate inferences regarding operation of the data processing systems, and the inferences may be used in downstream processes to increase a likelihood of desired operation of the data processing systems. For example, the inference models may be trained to infer information regarding occurrences of security events (e.g., security threats) to the data processing systems based on ingest data, and the operation of the data processing systems may be updated to mitigate (e.g., prevent) negative outcomes associated with the security events.

However, a quality (e.g., reliability) of the inferences used to manage the operation of the data processing systems may depend on a quality (e.g., informational content) of the ingest data provided to the (trained) inference models to obtain the inferences. For example, the ingest data may include a prompt (e.g., input from a downstream consumer of the inferences). If the informational content of the prompt is limited and/or ambiguous (e.g. insufficient), then the inference model may lack information required to generate an inference of expected quality.

To increase a likelihood of the informational content of the ingest data being sufficient, the prompt may be preprocessed through a data pipeline. The data pipeline may include a retrieval-augmented generation (RAG) process, during which context data (e.g., additional information regarding terms such as words and/or phases in the prompt) is obtained. The context data may be used to increase the informational content of the ingest data provided to the inference models. The context data may include various amounts of data chunks with differing time period associations. However, due to limitations of the RAG process, the context data may be insufficient to generate expected quality ingest data (e.g., ingest data with adequate informational content). For example, temporal information present in the prompt for which additional context is required may not be identified and/or sufficient context data may not be obtained for the temporal period referenced in the prompt.

Thus, to increase a likelihood of providing expected quality ingest data to the inference models, a portion of the data chunks (e.g., obtained during the RAG process) may be discriminated based on a relevant time period to identify temporally relevant data chunks. To do so, the relevant time period for use of the inference models may be defined. The relevant time period may be identified based on the prompt (e.g., explicit and/or implicit temporal information referenced in the prompt). A temporal relationship for each data chunk (e.g., obtained during the RAG process) may be compared to the relevant time period to determine whether the data chunk is temporally relevant to prompt 206. By doing so, data chunks that are temporally irrelevant may be excluded from the portion of data chunks used to generate expected quality ingest data and data chunks that are temporally relevant to prompt 206 may be more likely to be sufficient for improving the quality of ingest data to the inference models. Thus, improving a quality of inferences used to manage operation of the data processing systems.

In an embodiment, a method for managing service systems is provided. The method may include: obtaining a prompt that is to be processed by a trained machine learning model; generating a query based on the prompt; performing, using a similarity based search process and the query, a search of a data source to obtain data chunks; identifying a relevant time period based on, at least, the prompt; discriminating a portion of the data chunks based on the relevant time period to obtain temporally relevant data chunks; obtaining a response from the trained machine learning model using the prompt and the temporally relevant data chunks; and providing desired computer implemented services using the response.

The trained machine learning model may be a generative model, and the generative model may be based on a training data set that is not temporally constrained to the relevant time period.

The generative model may generate responses based on relationships present in the training data set, and the training data set may include at least one relationship of the relationships that may be irrelevant to the relevant time period.

The temporally relevant data chunks may be used as contextual information for prompt with the generative model so that the generative model excludes the at least one relationship from contributing to the response.

The data source may include a plurality of data chanks, the data chunks may be a subset of the plurality of the data chunks, and each data chunk of the data chunks may be tagged with metadata defining relevance of the respective data chunk with respect to the relevant time period.

The metadata may include a time of generation of the respective data chunk.

The metadata may include a version of the respective data chunk, and the version may be used as a proxy for a time of generation of the respective data chunk.

The relevant time period may be a sub-portion of a time period, and the trained machine learning model may be based on training data that has relevancy spanning the time period.

The discriminating may also identify a second portion of the data chunks based on the relevant time period to identify temporally irrelevant data chunks, wherein the temporally irrelevant data chunks may not be used in obtaining the response.

Discriminating the portion of the data chunks may include: for each data chunk of the data chunks: identifying a temporal relationship of the data chunk based on tags associated with the data chunk, the temporal relationship defining at least a time period associated with the respective data chunk; identifying whether the temporal relationship of the data chunk falls within the relevant time period; and in an instance of the identifying where the temporal relationship of the data chunk does not fall within the relevant time period: excluding the data chunk from the portion of the data chunks.

Providing the desired computer implemented services may include updating the operation of the data processing system.

The query may be services using a deterministic process, the deterministic process returning same results for repeated servicing of the query.

A non-transitory media may include instructions that when executed by a processor cause the computer-implemented method to be performed.

A system may include the non-transitory media and a processor, and may perform the computer-implemented method when the computer instructions are executed by the processor.

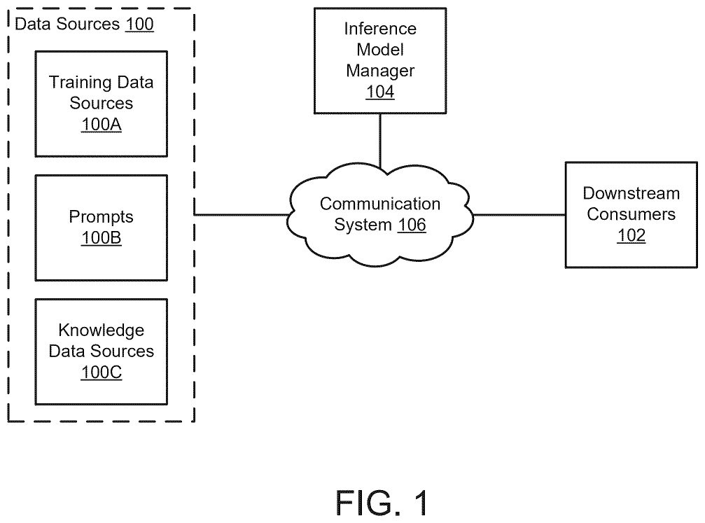

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing systems may be managed, for example, in accordance with policies (e.g., security policies, acceptable use policies). The policies may be enforced via updates to the operation of the data processing system over time to increase a likelihood of providing desired (e.g., secure, reliable) computer-implemented services.

The operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include information regarding programs being executed by components of a data processing system, and the inference model may be trained to identify, based on the ingest data, a security threat to the data processing system and/or actions for managing the security threat. To manage the security threat, the inference may be provided to a downstream process during which operation of the data processing system may be updated in a manner that mitigates an undesired outcome of the security threat.

However, the responses obtained from the (trained) inference models may not be reliable for managing the operation of the data processing systems if informational content of the ingest data used during inferencing is inadequate. For example, temporal terms (e.g., words and/or phrases) included in the prompt may be limited, ambiguous, and/or may have special meaning (e.g., a temporal term may have different meaning to an operator of the inference models than a meaning based on its dictionary definition). Therefore, to increase a likelihood of the ingest data having adequate informational content, the prompt may undergo preprocessing, during which context data may be obtained for temporal information included in the prompt.

For example, to obtain expected quality (e.g., adequate) ingest data, the prompt may be provided to a data pipeline. The data pipeline may include a retrieval-augmented generation (RAG) process, during which a query is derived based on the prompt, and a similarity based search process may, for example, used to search a trusted data source to obtain data chunks. While described with respect to performing a similarity based search process, it will be appreciated that other types of search processes may be used in the retrieval-augmented generation process.

However, due to limitations of these methods, not all of the data chunks may be temporally relevant to the prompt. Consequently, the data chunks may be insufficient for generating adequate ingest data. If the ingest data is inadequate, then a subsequent inferencing process that uses the inadequate ingest data may be likely to provide unreliable inferences, and outcomes of downstream processes (e.g., management processes for the data processing systems) that use the inferences may be undesirable.

In general, embodiments disclosed herein may provide methods, systems, and/or devices for managing operation of data processing systems using inference models in a manner that is more likely to result in desirable management outcomes. To do so, prompts for processing by the inference models may be preprocessed using an RAG process that identifies and filters data chunks based on a relevant time period (e.g., identified based on the prompt) to obtain temporally relevant data chunks. The relevant time period may be used to discriminate a portion of the data chunks that have temporal relationships that fall within the relevant time period and exclude the data chunks that are not temporally relevant to the prompt.

In contrast to the data chunks that have the temporal relationship to the relevant time period, an inference model may contain a wide variety of data that may not be associated with any particular time period (e.g., data associated with a variety of time periods). For example, the relevant time period may be a sub-portion of a time period in which training data with relevancy spanning the time period may be used to obtain a trained machine-learning model. Consequently, if a generalized prompt is ingested by the trained machine-learning model without specific temporal context, the resulting response may be undesirable (e.g., lacking temporal relevance and instead yield a generalized output that is independent of any time period).

By filtering data chunks based on the relevant time period, the temporally relevant data chunks obtained during prompt preprocessing may be more likely to be sufficient for providing adequate ingest data to the inference models, thereby increasing a likelihood of the inferences being reliable for use in managing the operation of the data processing systems.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

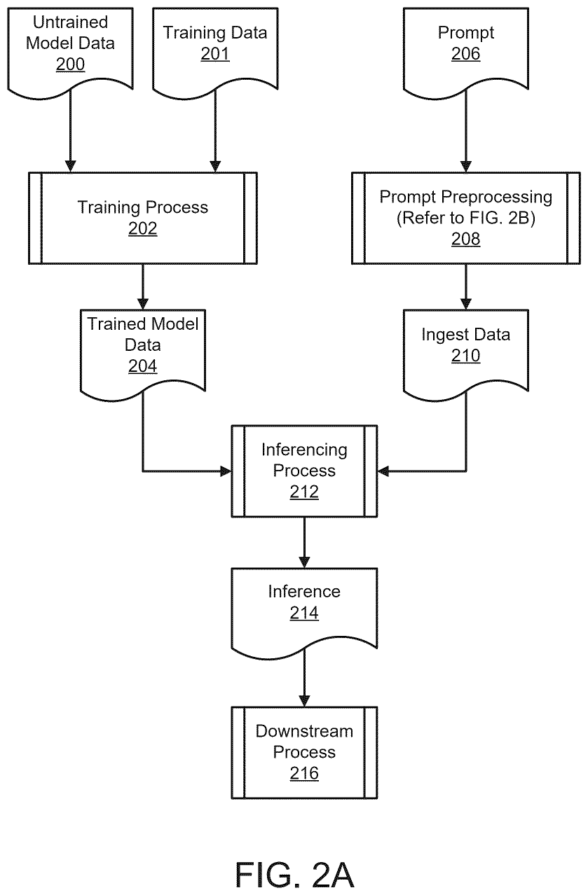

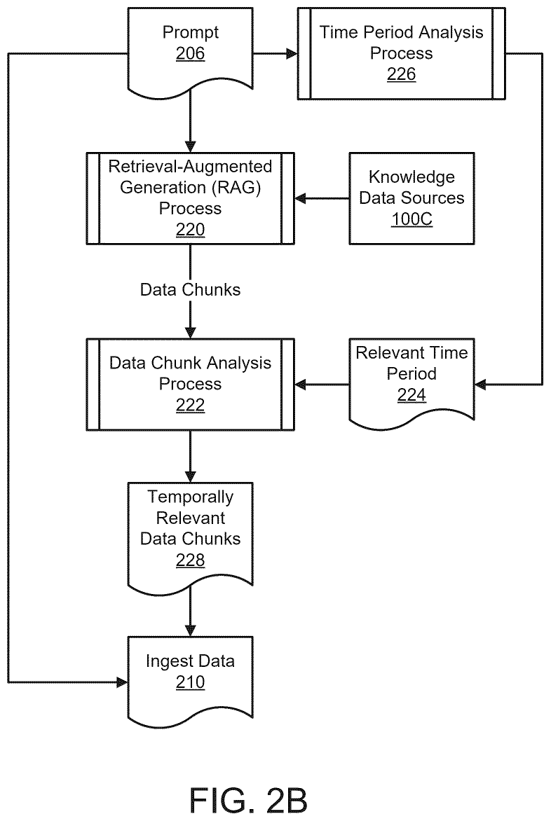

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of temporal information or information relevant to a time period, and may undergo preprocessing to obtain sufficient, tailored data (e.g., temporally relevant data) for generating adequate ingest data. Refer to the discussion of FIGS. 2A-2B for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding temporal relationships and/or metadata defining relevance of data chunks with respect to a time period, and may be queried during preprocessing of a prompt of prompts 100B (e.g., during a RAG process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models, and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform a first RAG process for the prompt to obtain context data, (iii) analyze the context data based on ontology definitions to identify instances of ontology terms present in the prompt for which the context data does not meet sufficiency criteria, (iv) perform additional RAG processes for the identified instances of ontology terms to obtain additional context data that meets the sufficiency criteria, and/or (v) obtain ingest data based on the prompt and/or the context data obtained during any of the performed RAG processes. Refer to the discussion of FIG. 2B for an example of an ontology-based iterative RAG process.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

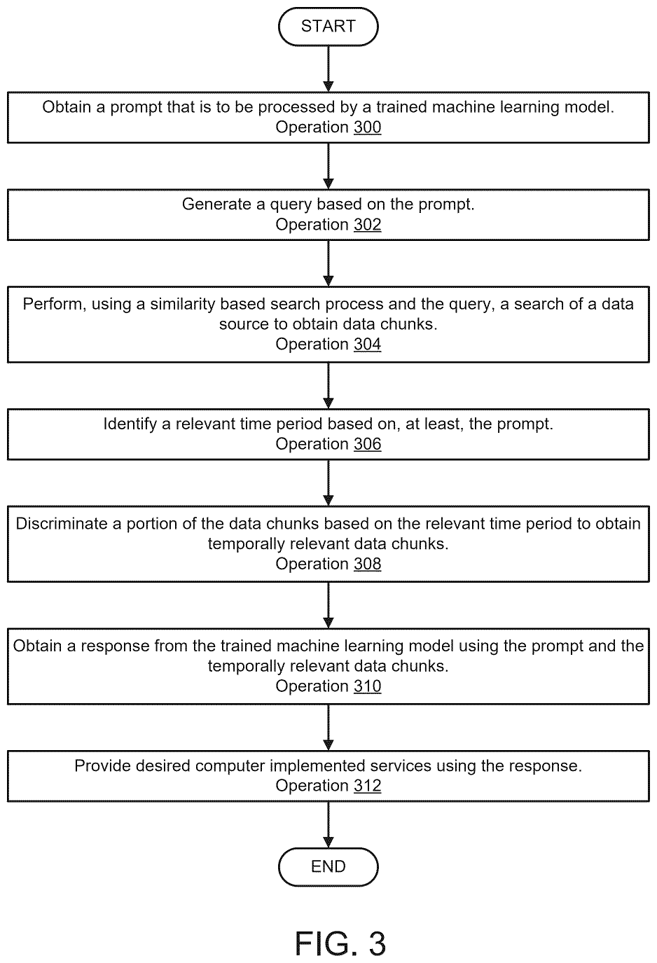

When providing their functionality, any of data sources 100, downstream consumers 102, inference model manager 104, and/or components thereof may perform all, or a portion of the actions and methods illustrated in FIGS. 2A-3.

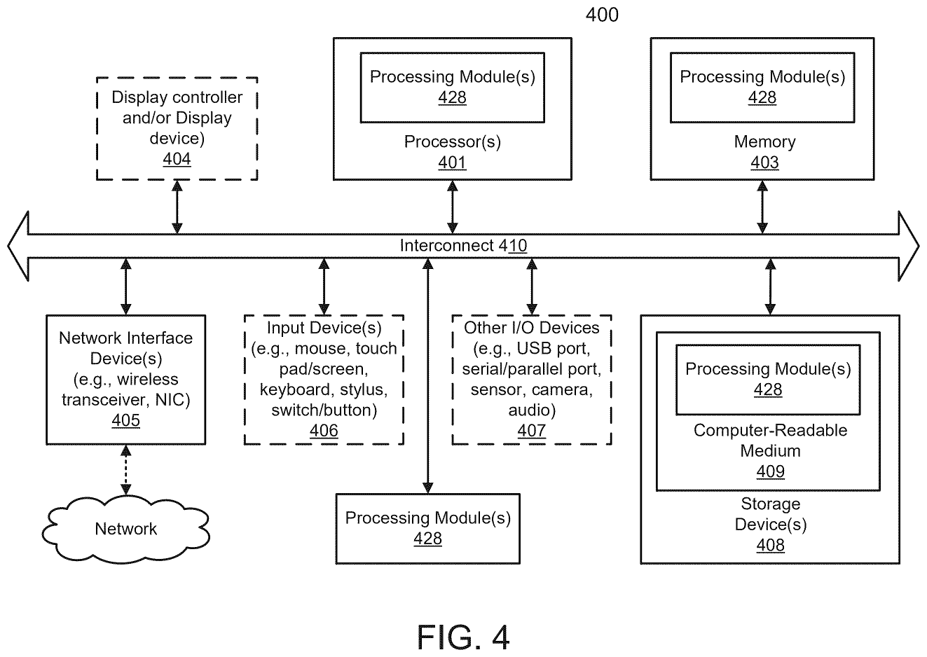

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210. For example, during inferencing process 212, a trained inference model may be obtained based on information (e.g., node information, weight information, connection information, activation functions, attention mechanisms, etc.) included in trained model data 204. Trained model data 204 may not be generated based on temporal distinctions and as such, the inferences generated during the inferencing process may not be temporally relevant.

For example, training data 201 may include a corpus of information spanning multiple years, covering various relationships or patterns from different periods of time and during the training process (e.g., training process 202), training data 201 may not be analyzed for temporal relevance. As a result, the trained inference model (e.g., obtained based on information included in trained model data 204) may not inherently recognize and/or prioritize these temporal distinctions when generating inferences in response to ingest data (e.g., when specific temporal relevance is required, such as generating responses specific to a particular year, month, event, etc.).

For example, training data 201 may include information regarding security threats and responses spanning multiple years, but training model data 204 may not distinguish between security threats prevalent in the year 2018 versus the security threats that emerged in the year 2022. The lack of temporal awareness may introduce challenges, for example, when inferences tailored to specific timeframes, such as the most effective response to a security threat observed in a particular year and/or during a specific type of attack.

To increase a likelihood that inferences generated by the trained inference model are relevant to a prompt (e.g., prompt 206), a retrieval augmented generation (RAG) process may be performed. During a RAG process, data chunks may be utilized as part of ingest data packages for the trained inference model (e.g., the data chunks being used as context for inference generation by the trained inference model). In addition, conventional RAG processes may also not temporally limit the data chunks retrieved. Consequently, neither mechanism through which responses are generated, conventionally, generate temporally limited responses. To address this problem, the data chunks retrieved (during the retrieval augmented generation process performed as part of prompt preprocessing 208) may be limited based on temporal relevance. For example, ingest data 210 may be obtained and may include temporally relevant data chunks (e.g., the temporally limited context data).

Ingest data 210 may include a portion of data for which an inference is desired to be obtained. For example, ingest data 210 may include prompt 206 (e.g., of prompts 100B). Prompt 206 may be obtained, for example, from a consumer of inferences and may include references to a specific temporal period. To obtain ingest data 210 (e.g., an enhanced version of prompt 206), prompt 206 may undergo prompt preprocessing 208. For example, during prompt preprocessing 208, context data that is relevant to the temporal period included in prompt 206 may be obtained, and ingest data 210 may be generated based on prompt 206 and/or the temporally relevant context data. For example, during prompt preprocessing 208, data chunks may be selected based on temporal information so that the context data provided in ingest data 210 is temporally limited based on temporal parameters indicated by prompt 206. Refer to the discussion of FIG. 2B for more details regarding prompt preprocessing and/or obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate informational content), temporal information included in prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, temporally relevant data chunks for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system.

To obtain temporally relevant data chunks for prompt 206, time period analysis process 226 may be performed. Time period analysis process 226 may include any type of process(es) wherein information (e.g., words, terms, etc.) relevant to a time period present in a prompt is identified. For example, time period analysis process 226 may implement natural language processes to extract explicit and/or implied temporal information.

For example, a prompt (e.g., prompt 206) may include explicit dates (e.g., directly stated dates, years, or time ranges), relative time phrases (e.g., “last year”, “in the future”, etc.), implied temporal context (e.g., event-driven context such as known historical, cultural, or contextual events), recurring events (e.g., cyclical or seasonal references), and/or any other information usable to identify temporal relationship. For example, during time period analysis process 226, a prompt (e.g., prompt 206) including text such as “computer sales data for last year” may be parsed and using contextual interpretation of “last year” the relevant time period may be identified as 2023 (assuming the year is 2024).

As a result of performing time period analysis process 226, relevant time period 224 may be obtained. Relevant time period 224 may include any type of information identifying a time period relevant to the prompt. Relevant time period 224 may be used in performing data chunk analysis process 222 to discriminate a portion of data chunks that are temporally relevant to prompt 206.

To obtain the data chunks for prompt 206, retrieval-augmented generation (RAG) process 220 may be performed. RAG process 220 may include any type of process(es) wherein information (e.g., terms) present in a prompt is identified, and additional information is retrieved from a data source based on the identified information. For example, RAG process 220 may implement naïve RAG, modular RAG, query-based RAG, multi-modal RAG, and/or other types of data retrieval processes. During RAG process 220, a prompt (e.g., prompt 206) may be obtained and used to generate a query (e.g., a keyword search query). The query may then be used to search an external data source such as knowledge data sources 100C to identify responsive portions of data stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with metadata defining a time period relative to the respective data chunk. For example, each data chunk may be tagged with metadata including a time of generation of the data chunk (e.g. time period in which the data was generated), a version (e.g., being used a proxy for the time of generation) for the data chunk, and/or any other information relevant to temporal relationships.

During performance of RAG process 220, a query may be generated based on prompt 206 and used to perform a search of a data source to obtain data chunks responsive to the prompt. The query may be derived from terms (e.g., words and/or phrases) presented in prompt 206. The query may be serviced using a deterministic process (e.g., using a trained deterministic inference model and/or any process that returns the same results for repeated servicing of the query). For example, the query may be used to identify portions of data responsive to terms included in the query (e.g., data chunks) from knowledge data sources 100C. For example, a search of a data source (e.g., knowledge data sources 100C) may be performed using a similarity based search process.

The identified portions of data responsive to the query may then be ranked for relevance using a relevance ranking algorithm. Some number (e.g., best hits) of the ranked portions of data may then be selected for use as the data chunks. However, due to limitations of the relevance ranking algorithm and/or selection criteria, the data chunks may include data irrelevant to the time period referenced and/or identified in prompt 206. Therefore, to address these limitations of RAG process 220, data chunk analysis process 222 may be performed.

During data chunk analysis process 222, data chunks obtained from RAG process 220 may be analyzed using relevant time period 224 to obtain temporally relevant data chunks 228. For example, a portion of the data chunks may be discriminated based on the relevant time period. As described above, relevant time period 224 may include information identifying a time period relevant to the prompt, and may be, for example, a sub-portion of a time period wherein the trained machine learning model (e.g., trained model data 204) may be based on training data (e.g., training data 201) that has relevancy spanning the time period.

During data chunk analysis process 222, a temporal relationship for each of the data chunks (e.g. identified during RAG process 220) may be identified and used to determine whether the temporal relationship falls within the relevant time period (e.g., 224). For example, the metadata of the data chunks may be analyzed to identify a time period associated with the data chunk. The data chunk may include, for example, a text document with a title including the text “May 2023 Sales Data” and based on the metadata, the time period or temporal relationship of the data chunk may be identified as “May 2023”.

In addition, the temporal relationship of the data chunks may be identified by performing content analysis of the data chunk. Continuing the above example, the data chunk may include a table that breaks down sales for each day within the month of May 2023, and by using natural language processing, additional information for temporal relevance may be identified based on the content of the data chunk.

Once identified, the temporal relationship (e.g., time period) for the data chunk may be compared to the relevant time period 224 to identify whether the data chunk is relevant to the time period referenced by the prompt. If the temporal relationship of the data chunk does not fall within the relevant time period (e.g., identified based on prompt 206), then the data chunk may be identified as temporally irrelevant data chunks and may be excluded from the portion of data chunks that are temporally relevant to prompt 206 (e.g., and used in obtaining the response). Continuing the above example, if the temporal relationship of the data chunk is identified to be relevant to “May 2023” and the relevant time period includes data relevant to “December 2023”, then the data chunk may be identified as a “second portion” of the data chunks which may include temporally irrelevant data chunks based on prompt 206.

If the temporal relationship of the data chunk does fall with the relevant time period (e.g., identified based on prompt 206), then the data chunk may included in the portion of data chunks that are relevant to prompt 206 (e.g., temporally relevant data chunks 228). For example, if the temporal relationship of the data chunk is identified to be relevant to “October-December 2023” and the relevant time period includes data relevant to “December 2023”, then the data chunk may be identified as temporally relevant and may be included in the portion of temporally relevant data chunks 228.

Temporally relevant data chunks 228 may include filtered data chunks (e.g., obtained during RAG process 220) based on the time period relevant (e.g., relevant time period 224) to the prompt. Temporally relevant data chunks 228 may be used, in part, to obtain ingest data 210. For example, ingest data 210 may include temporally relevant data chunks 228 (e.g., the filtered data chunks based on the relevant time period) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the above example, the response obtained from the inference model (e.g., inference 214 in FIG. 2A) during the inferencing process may indicate that program A is likely to include malicious code, and that file F is not expected to be accessed by program A during desired operation of data processing system D. The response may indicate that a security policy for data processing system D should be enforced (e.g., which may occur during downstream process 216 of FIG. 2A).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using data flows shown in FIG. 2B, a quality of ingest data to inference models may be improved using temporal information obtained from a prompt. The temporal information may be used to filter data chunks identified via an RAG process to produce sufficient contextual information for instance of temporal specifications present in prompts submitted for processing by the inference models. By doing so, inferences obtained based on the ingest data may be more likely to be reliable for managing operation of data processing systems, and the data processing systems may be more likely provide desired computer-implemented services.

Turning to FIG. 3, a flow diagram illustrating a method in accordance with an embodiment is shown. The flow diagram may illustrate various operations performed while managing operation of a data processing system.

At operation 300, a prompt that is to be processed by a trained machine learning model may be obtained. Obtaining the prompt may include: (i) receiving the prompt from an external entity, (ii) reading the prompt from storage, and/or (iii) any other method.

At operation 302, a query may be generated based on the prompt. Generating the query based on the prompt may include: (i) deriving the query through any type of process and/or type of (pre-established) algorithm for analyzing the prompt, (ii) receiving the query from an external entity, and/or (iii) by other methods. For example the query may be generated using a trained deterministic inference model, deterministic function, and/or any process that returns the same results for the same input (e.g., contextual information from the prompt).

At operation 304, a search of a data source may be performed to obtained data chunks. The search of the data source may be performed using a similarity based search process and the query. The first RAG process may be performed by methods described with respect to RAG process 220 of FIG. 2B and/or by other methods. For example, performing the search of the data source to obtained data chunks may include: (i) using the query to search a data source to retrieve data responsive to the query, (ii) obtaining the data chunks based on at least a portion of the data responsive to the query, and/or (iii) by other methods. Using the query to search the data source may include performing any type of comparison process wherein the query (e.g., derived from the prompt) is compared to a dataset to identify items (e.g., words, phrases, etc.) most closely matching the query based on a measure of similarity.

At operation 306, a relevant time period may be identified based at least on the prompt. Identifying the relevant time period may be performed by methods described with respect to time period analysis process 226 of FIG. 2B and/or by other methods. For example, identifying the relevant time period may be performed by analyzing the prompt to identify words, phrases, and/or metadata that relate to a time period. For example, performing contextual analysis (e.g., using natural language processing) of a prompt such as “Christmas Sales Data for last year” may include parsing the prompt and identifying the terms/phrases “Christmas” and “last year” to determine the relevant time period (e.g., December 2023).

At operation 308, a portion of the data chunks may be discriminated based on the relevant time period to obtain temporally relevant data chunks. Discriminating the portion of the data chunks may include: for each data chunk of the data chunks: (i) identifying a temporal relationship of the data chunk based on tags associated with the data chunk, the temporal relationship defining at least a time period associated with the respective data chunk; identifying whether the temporal relationship of the data chunk falls within the relevant time period; and in an instance of the identifying where the temporal relationship of the data chunk does not fall within the relevant time period: excluding the data chunk from the portion of the data chunks.

The temporal relationship of the data chunk may be identified by performing any type of analysis process of the tags associated with the data chunk. For example, the data chunk may be tagged with metadata that includes the time of generation, the version of the data chunk, and/or any other type of information defining a time period in which the data chunk was generated.

Identifying whether the temporal relationship of the data chunk falls within the relevant time period may include performing any type of comparison process using the relevant time period and the temporal relationship (e.g., for the respective data chunk) to determine if the time period (e.g., identified by the temporal relationship of the data chunk) is within the relevant time period.

At operation 310, a response may be obtained from the trained machine learning model using the prompt and the temporally relevant data chunks. The response may be obtained by: (i) receiving the response (e.g., from another device), (ii) reading the response (e.g., from storage), and/or (iii) generating the response. The response may be generated using methods described with respect to FIG. 2A and/or by other methods. For example, the response may be obtained by (i) obtaining (e.g., training) the trained machine learning model, (ii) obtaining (e.g., generating) ingest data for the trained machine learning model, and/or (iii) providing the ingest data to the trained machine learning model for processing.

For example, in the first instance of the determination at operation 302 where the first context data meets the sufficiency criteria, then the ingest data may be obtained by generating a data package that includes the prompt and the first context data; or, in the second instance of the determination at operation 302 where the first context data does not meet the sufficiency criteria (e.g., and where a combination of the first and second context data does meet the sufficiency criteria), then the ingest data may be obtained by generating a data package that includes the prompt, the first context data, and the second context data.

At operation 312, desired computer implemented services may be provided using the response. Providing the desired computer implemented services using the response may include: (i) providing the response to a downstream consumer as a first portion of the desired computer-implemented services, (ii) providing the response to a downstream process to obtain an output from the downstream process, and/or (ii) using the output from the downstream process to provision a second portion of the desired computer-implemented services.

Using the response may include updating the operation of the data processing system. For example, the response may include information regarding policies that should be enforced in order to increase a likelihood of providing the desired computer-implemented services in view of information included in the prompt, the data chunks, the relevant time period, and/or any other information. Refer to the discussion of FIGS. 2A-2B for more details regarding use of the response and/or updating the data processing system.

The method may end following operation 312.

Thus, as illustrated above, embodiments disclosed herein may provide systems and methods for managing context data retrieval for ingest data to inference models used to manage operation of a data processing system. By increasing a likelihood of receiving sufficient context data, the resulting ingest data may be more likely to facilitate reliable inferencing by the inference models. As a result, the data processing system may be more likely to be updated reliably (e.g., appropriately, timely), and the computer-implemented services provided by the data processing systems may be more likely to be desired computer-implemented services.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system, the method comprising:
obtaining a prompt that is to be used by a trained machine learning model to generate a response comprising an inference associated with operations of the data processing system;
performing a prompt processing process to increase a reliability of the inference generated using the prompt from a first degree of reliability to a second degree of reliability higher than the first degree of reliability by at least:
generating a query based on the prompt;
performing, using a similarity based search process and the query, a search of a data source to obtain data chunks;
identifying, using only explicit and implicit temporal terms included in the prompt. a relevant time period for the prompt;
discriminating the data chunks based on the relevant time period to obtain temporally relevant data chunks from among the data chunks;
causing the trained machine learning model to generate the response using the prompt and only the temporally relevant data chunks from among the data chunks; and
using the response to manage operations of the data processing system to cause the data processing system to provide one or more desired computer implemented services.

2. The method of claim 1, wherein the trained machine learning model is a generative model, and the generative model is based on a training data set that is not temporally constrained to the relevant time period.

3. The method of claim 2, wherein the generative model generates responses based on relationships present in the training data set, and the training data set comprises at least one relationship of the relationships that is irrelevant to the relevant time period.

4. The method of claim 3, wherein the temporally relevant data chunks are used as contextual information for the prompt to cause the generative model, when generating the response using the prompt, to exclude the at least one relationship that is irrelevant to the relevant time period from contributing to the response.

5. The method of claim 1, wherein the data source comprises a plurality of data chunks, the data chunks being a subset of the plurality of the data chunks, and each data chunk of the data chunks being tagged with metadata defining relevance of a respective data chunk with respect to the relevant time period.

6. The method of claim 5, wherein the metadata comprises a time of generation of the respective data chunk.

7. The method of claim 5, wherein the metadata comprises a version of the respective data chunk, and the version being used as a proxy for a time of generation of the respective data chunk.

8. The method of claim 1, wherein the relevant time period is a sub-portion of a time period, and the trained machine learning model is based on training data that has relevancy spanning the time period.

9. The method of claim 1, wherein the discriminating of the data chunks further comprises obtaining temporally irrelevant data chunks from among the data chunks, wherein the temporally irrelevant data chunks are not used in obtaining the response.

10. The method of claim 1, wherein discriminating the data chunks comprises:
for each data chunk of the data chunks:
identifying a temporal relationship of the data chunk based on tags associated with the data chunk, the temporal relationship defining at least a time period associated with the data chunk;
identifying whether the temporal relationship of the data chunk falls within the relevant time period; and
in an instance of the identifying where the temporal relationship of the data chunk does not fall within the relevant time period:
excluding the data chunk from among the data chunks.

11. The method of claim 1, wherein using the response to manage operations of the data processing system to cause the data processing system to provide one or more desired computer implemented services comprises:
updating the operation of the data processing system by modifying one or more hardware or software components of the data processing system.

12. The method of claim 1, wherein the query is serviced using a deterministic process, the deterministic process returning same results for repeated servicing of the query.

13. A non-transitory machine-readable medium having instructions stored therein, which when executed by a processor, cause the processor to perform operations for managing operation of a data processing system, the operations comprising:
obtaining a prompt that is to be used by a trained machine learning model to generate a response comprising an inference associated with operations of the data processing system;
performing a prompt processing process to increase a reliability of the inference generated using the prompt from a first degree of reliability to a second degree of reliability higher than the first degree of reliability by at least:
generating a query based on the prompt;
performing, using a similarity based search process and the query, a search of a data source to obtain data chunks;
identifying, using only explicit and implicit temporal terms included in the prompt, a relevant time period for the prompt;
discriminating the data chunks based on the relevant time period to obtain temporally relevant data chunks from among the data chunks;
causing the trained machine learning model to generate the response using the prompt and only the temporally relevant data chunks from among the data chunks; and
using the response to manage operations of the data processing system to cause the data processing system to provide one or more desired computer implemented services.

14. The non-transitory machine-readable medium of claim 13, wherein the trained machine learning model is a generative model, and the generative model is based on a training data set that is not temporally constrained to the relevant time period.

15. The non-transitory machine-readable medium of claim 14, wherein the generative model generates responses based on relationships present in the training data set, and the training data set comprises at least one relationship of the relationships that is irrelevant to the relevant time period.

16. The non-transitory machine-readable medium of claim 15, wherein the temporally relevant data chunks are used as contextual information for the prompt to cause the generative model, when generating the response using the prompt, to exclude the at least one relationship that is irrelevant to the relevant time period from contributing to the response.

17. A system, comprising:
a processor; and
a memory coupled to the processor to store instructions, which when executed by the processor, cause operations for managing operation of a data processing system to be performed, the operations comprising:
obtaining a prompt that is to be used by a trained machine learning model to generate a response comprising an inference associated with operations of the data processing system;
performing a prompt processing process to increase a reliability of the inference generated using the prompt from a first degree of reliability to a second degree of reliability higher than the first degree of reliability by at least:
generating a query based on the prompt;
performing, using a similarity based search process and the query, a search of a data source to obtain data chunks;
identifying, using only explicit and implicit temporal terms included in the prompt, a relevant time period for the prompt;
discriminating the data chunks based on the relevant time period to obtain temporally relevant data chunks from among the data chunks;
causing the trained machine learning model to generate the response using the prompt and only the temporally relevant data chunks from among the data chunks; and
using the response to manage operations of the data processing system to cause the data processing system to provide one or more desired computer implemented services.

18. The system of claim 17, wherein the trained machine learning model is a generative model, and the generative model is based on a training data set that is not temporally constrained to the relevant time period.

19. The system of claim 18, wherein the generative model generates responses based on relationships present in the training data set, and the training data set comprises at least one relationship of the relationships that is irrelevant to the relevant time period.

20. The system of claim 19, wherein the temporally relevant data chunks are used as contextual information for the prompt to cause the generative model, when generating the response using the prompt, to exclude the at least one relationship that is irrelevant to the relevant time period from contributing to the response.
